(19) United States
(12) Patent Application Publication
(10) Pub. No.: US 2012/0174559 A1
(43) Pub. Date: Jul. 12, 2012

(54) SYSTEM AND METHOD FOR CONTROLLING A GAS TURBINE ENGINE AFTERBURNER

(75) Inventors: Richard Ling, Scottsdale, AZ (US); Karl Keppler, Chandler, AZ (US); Kevin Shepherd, Phoenix, AZ (US); Mark Lee Denton, Tempe, AZ (US)

(73) Assignee: HONEYWELL INTERNATIONAL INC., Morristown, NJ (US)

(21) Appl. No.: 12/986,493

(22) Filed: Jan. 7, 2011

(51) Int. Cl. F02K 3/10

(52) U.S. Cl. 60/204; 60/761

(57) ABSTRACT

Methods and apparatus are provided for operating a gas turbine engine. In a first operational mode, the gas turbine engine generates thrust using the propulsion turbine and not the afterburner when it is commanded to generate a thrust between at least a first thrust magnitude and a second thrust magnitude, and generates thrust using the propulsion turbine and the afterburner when it is commanded to generate thrust greater than the second thrust magnitude. In a second operational mode, the gas turbine engine generates thrust using the propulsion turbine and the afterburner when it is commanded to generate a thrust greater than the first thrust magnitude. The steady state thrust-versus-throttle position response has a substantially constant linear slope that is set to be two times the similar slope of the first operational mode. Thrust transients of the propulsion turbine and the afterburner are substantially synchronizing when the gas turbine engine is operating in the second mode and generating thrust greater than first thrust magnitude.

### TECHNICAL FIELD

The present invention generally relates to gas turbine engine control, and more particularly relates to systems and methods for controlling a gas turbine engine afterburner.

### BACKGROUND

Some aircraft gas turbine propulsion engines are equipped with an afterburner. An afterburner (or reheat) is typically disposed downstream of the turbine and upstream of the exhaust nozzle, and includes a plurality of fuel injectors. The afterburner provides increased thrust by injecting fuel, via the fuel injectors, into the exhaust section of the engine downstream of the turbine. An afterburner may be used to provide increased thrust for supersonic flight, for takeoff and, in the case of military aircraft, for combat situations. No matter the reason for its specific use, an afterburner in an aircraft gas turbine propulsion engine is typically activated only after the propulsion turbine has reached its maximum speed and thrust. This is because afterburner fuel efficiency is usually relatively poor as compared to the main engine.

A pilot typically controls the thrust delivered by an aircraft gas turbine propulsion engine via a throttle device, such as a lever. More specifically, an engine control receives signals representative of the position of the throttle device and, in response, controls the speed of, and thrust delivered by, the engine. The throttle position, or power lever angle (PLA) as it is sometimes referred to, is typically a position that falls within one of two position ranges, a lower range and an upper range. The lower throttle position range is used to command propulsion engine speeds between idle engine speed and maximum engine speed, and thus command generated propulsion engine thrust between idle and maximum engine thrust levels. The upper throttle position range is used to modulate afterburner thrust between minimum and maximum afterburner thrust levels, while the propulsion engine remains at maximum engine speed.

Though highly unlikely, for many twin-engine aircraft an event is postulated in which one of the propulsion engines becomes inoperable. Typically, continued operation of the aircraft with a single propulsion engine has little, if any, impact. However, under certain situations, such as during a landing maneuver, it may be desirable for the pilot at least periodically activate the afterburner on the operable propulsion engine in order to generate sufficient thrust to follow the glide slope during descent. Moreover, for military aircraft it may be desirable for the pilot to activate the afterburners during certain combat maneuvers, whether one or both engines are operable.

Unfortunately, activating and deactivating the afterburner during landing or combat maneuvers can create a thrust discontinuity due to a delay in afterburner activation and a subsequent thrust jump. As a result, the pilot may not be able to smoothly and precisely modulate thrust during such maneuvers. During a landing maneuver, this can undesirably cause the aircraft to drift off of the glide slope. In addition, during single propulsion engine operation, the thrust response to throttle device movements is basically cut in half This means the pilot will need to move the throttle device twice the distance in order to get the same thrust change as when both propulsion engines were operating. The pilot may also need to move the throttle device into and out of the upper position range in order to get the same thrust level, and same thrust level change, that is available when both propulsion engines are operating. This can cause the pilot to have to make numerous and instant adjustments to the throttle position during landing, which can be both physically and mentally taxing.

Hence, there is a need for a system and method of controlling a gas turbine engine afterburner that provides relatively smooth and precise thrust modulation at propulsion engine speeds below maximum speed and/or that does not require a pilot to move the throttle device an inordinate distance to achieve a desired thrust level from a gas turbine engine during single engine operation of a twin-engine aircraft. The present invention addresses one or more of these needs.

### BRIEF SUMMARY

In one embodiment, a method of operating a gas turbine engine that includes a propulsion turbine and an afterburner includes operating the gas turbine engine in a first operational mode and selectively operating the gas turbine engine in a second operational mode. In the first operational mode, the gas turbine engine generates thrust using the propulsion turbine and not the afterburner when the gas turbine engine is commanded to generate a thrust between at least a first thrust magnitude and a second thrust magnitude, and the gas turbine engine generates thrust using the propulsion turbine and the afterburner when the gas turbine engine is commanded to generate thrust greater than the second thrust magnitude. In the second operational mode, the gas turbine engine generates thrust using the propulsion turbine and the afterburner when the gas turbine engine is commanded to generate a thrust greater than the first thrust magnitude.

In another embodiment, a method of controlling a gas turbine engine that generates thrust using a propulsion turbine and an afterburner includes commanding the gas turbine engine to undergo a thrust transient and thereby change the generated thrust from a first thrust magnitude to a second thrust magnitude. The propulsion turbine is controlled to undergo a propulsion turbine thrust transient, and the afterburner is controlled to undergo an afterburner thrust transient. The afterburner thrust transient is substantially synchronized to the propulsion turbine thrust transient while the generated thrust is changing from the first thrust magnitude to the second thrust magnitude.

In yet another embodiment, a gas turbine engine control system includes a gas turbine engine and an engine control. The gas turbine engine includes a propulsion turbine and an afterburner. The engine control is adapted to receive input commands representative of a commanded thrust and is configured, in response to the input commands, to: (1) control the gas turbine engine to generate propulsion thrust using the propulsion turbine and not the afterburner when the commanded thrust is at least between a first thrust magnitude and a second thrust magnitude, (2) control the gas turbine engine to generate propulsion thrust using both the propulsion turbine and the afterburner when the commanded thrust is greater than the second thrust magnitude, and (3) selectively control the gas turbine engine to generate propulsion thrust using both the propulsion turbine and the afterburner when the commanded thrust is greater than the first thrust magnitude.

In still another embodiment, a gas turbine engine control system includes a gas turbine engine and an engine control. The gas turbine engine includes a propulsion turbine and an afterburner, and is configured to at least selectively generate thrust using the propulsion turbine and the afterburner. The engine control is adapted to receive input commands representative of a change in generated thrust from a first thrust magnitude to a second thrust magnitude, the engine control configured, in response to the input commands, to: (1) control the propulsion turbine to undergo a propulsion turbine thrust transient, (2) control the afterburner to undergo an afterburner thrust transient, and (3) substantially synchronize the afterburner thrust transient to the propulsion turbine thrust transient while the generated thrust is changing from the first thrust magnitude to the second thrust magnitude.

Furthermore, other desirable features and characteristics of the gas turbine engine control system and method will become apparent from the subsequent detailed description and the appended claims, taken in conjunction with the accompanying drawings and the preceding background.

### BRIEF DESCRIPTION OF THE DRAWINGS

Embodiments of the present invention will hereinafter be described in conjunction with the following drawing figures, wherein like numerals denote like elements, and wherein:

FIG. 1 depicts a functional block diagram of an exemplary gas turbine engine control system;

FIG. 2 depicts a functional block diagram of a portion of the control logics that the engine control depicted in FIG. 1 may be use to control the gas turbine engine depicted in FIG. 1;

FIG. 3 graphically depicts a steady state thrust-versus-throttle position response of the gas turbine engine depicted FIG. 1, when it is being controlled in a first operational mode;

FIG. 4 graphically depicts a steady state thrust-versus-throttle position response of the gas turbine engine depicted FIG. 1, when it is being controlled in a second operational mode;

FIG. 5 simultaneously depicts the steady state thrust-versus-throttle position response of the gas turbine engine of FIGS. 3 and 4;

FIG. 6 depicts a functional block diagram of an embodiment of a part throttle reheat control logic that may be implemented in the engine control of FIG. 1; and

FIG. 7 depicts a more detailed functional schematic diagram of an embodiment the part throttle reheat control logic depicted in FIG. 6.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

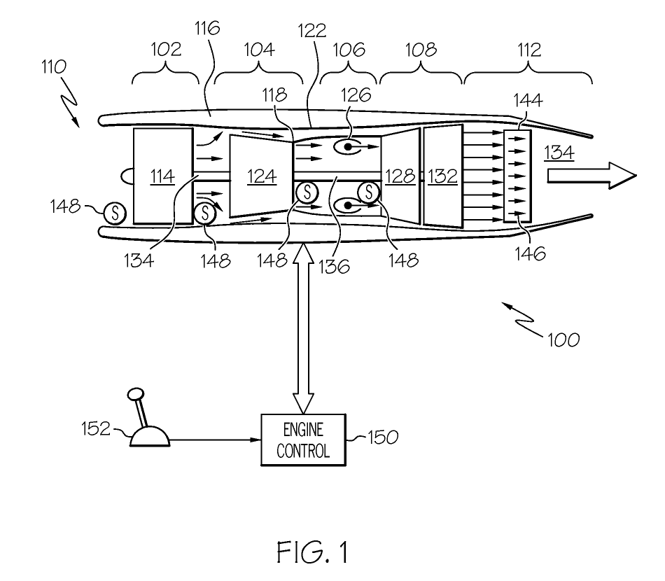

Turning now to FIG. 1, a functional block diagram of an exemplary gas turbine engine control system 100 is depicted. The depicted engine control system 100 includes a gas turbine engine 110 and an engine control 150. The gas turbine engine 110, at least in the depicted embodiment, is a multi-spool turbofan gas turbine engine, and includes an intake section 102, a compressor section 104, a combustion section 106, a propulsion turbine 108, and an exhaust section 112. The intake section 102 includes a fan 114, which is mounted in a fan case 116. The fan 114 draws air into the intake section 102 and accelerates it. A fraction of the accelerated air exhausted from the fan 114 is directed through a bypass section 118 disposed between the fan case 116 and an engine cowl 122, and provides a forward thrust. The remaining fraction of air exhausted from the fan 114 is directed into the compressor section 104.

The compressor section 104 may include one or more compressors 124, which raise the pressure of the air directed into it from the fan 114, and directs the compressed air into the combustion section 106. In the depicted embodiment, only a single compressor 124 is shown, though it will be appreciated that one or more additional compressors could be used. In the combustion section 106, which includes a combustor assembly 126, the compressed air is mixed with fuel supplied from a non-illustrated fuel source. The fuel and air mixture is combusted, and the high energy combusted air mixture is then directed into the propulsion turbine 108.

The propulsion turbine 108 includes one or more turbines. In the depicted embodiment, the propulsion turbine 108 includes two turbines, a high pressure turbine 128, and a low pressure turbine 132. However, it will be appreciated that the propulsion turbine 108 could be implemented with more or less than this number of turbines. No matter the particular number, the combusted air mixture from the combustion section 106 expands through each turbine 128, 132, causing it to rotate. The combusted air mixture is then exhausted through a propulsion nozzle 134 disposed in the exhaust section 114, providing additional forward thrust. As the turbines 128 and 132 rotate, each drives equipment in the engine 100 via concentrically disposed shafts or spools. Specifically, the high pressure turbine 128 drives the compressor 124 via a high pressure spool 136, and the low pressure turbine 132 drives the fan 114 via a low pressure spool 138.

As FIG. 1 further depicts, an afterburner 144 is disposed downstream of the propulsion turbine 108 and upstream of the propulsion nozzle 134, and includes a plurality of fuel injectors 146. When the afterburner 144 is activated, fuel from the above-mentioned non-illustrated fuel source is supplied to the fuel injectors 146. The fuel discharged from the fuel injectors 146 is mixed with the bypass air and the combusted air mixture that is discharged from the propulsion turbine 108. The heat of the combusted air mixture combusts the fuel, which generates additional thrust, on top of the thrust generated by the propulsion turbine 108 bypass air.

A plurality of sensors 148 may additionally be disposed in or near the gas turbine engine 110. Each of the sensors 148 is in operable communication with the engine control 150 and is operable to sense an engine parameter and supply data representative of the sensed parameter to the engine control 150. It will be appreciated that the particular number, type, and location of each sensor 148 may vary. It will additionally be appreciated that the number and types of parameter data supplied by the sensors 148 may vary depending, for example, on the particular engine type and/or configuration. In the depicted embodiment, however, at least a subset of the depicted sensors 148 supply data representative of, or that may be used to determine, engine inlet pressure, engine inlet temperature, engine rotational speed, fuel flow, compressor discharge pressure, turbine inlet temperature, engine torque, shaft horsepower, and thrust, to name just a few.

The engine control 150, which may be implemented within an engine controller, such as a Full Authority Digital Engine Controller (FADEC) or other electronic engine controller (EEC), controls the thrust generated by the propulsion engine 110. To do so, the engine control 150 receives various input signals, and controls, among other parameters, the flow of fuel to the combustor assembly 126, to the afterburner 144, or to both, to thereby control the thrust generated by the gas turbine engine 110. In the depicted embodiment, the engine control 150 receives input commands representative of a commanded engine thrust from a throttle device 152 (e.g., power lever) that is located in, for example, a non-illustrated cockpit. The engine control 150 is configured, in response to the input commands, to control the gas turbine engine 110 to generate propulsion thrust using the propulsion turbine 108, or using the propulsion turbine 108 and the afterburner 144.

Before proceeding further, it is noted that in the preceding paragraph, and in all further descriptions, it is assumed that the gas turbine engine 110, when it is implemented as a turbofan engine, also generates thrust via the fan bypass air. Thus, when it is stated above or in any preceding paragraphs that the gas turbine engine 110 generate propulsion thrust using only the propulsion turbine 108 or using the propulsion turbine 108 and the afterburner 144, it is assumed in both instances that a portion of the overall thrust being generated is supplied via the fan bypass air.

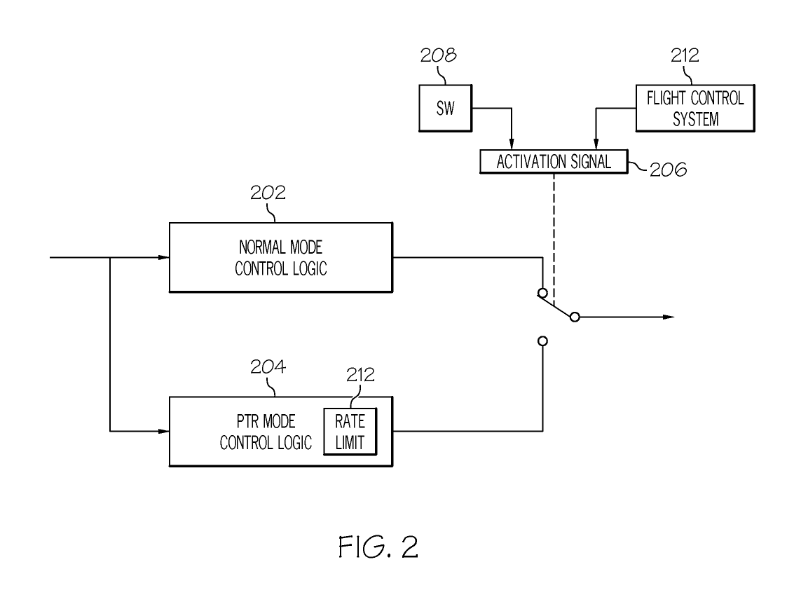

Returning now to the description, the engine control 150 is configured to control the gas turbine engine 110 to operate in one of two operational modes—a first operational mode (or “normal” mode) or a second operational mode (or “part throttle reheat (PTR)” mode). To do so, as is shown more clearly in FIG. 2, the engine control 150 is configured to implement two different control logics—a first (or “normal mode”) control logic 202 and a second (or “PTR mode”) control logic 204. The engine control 150 is normally configured to control the gas turbine engine 110 via the first control logic 202. However, upon receipt of an activation signal 206, the engine control 150 is configured to control the gas turbine engine 110 via the second control logic 204. The activation signal 206 may be supplied from either a manual switch 208 located in the non-illustrated cockpit or from the aircraft flight control system 212. If the activation signal 206 is supplied from the aircraft flight control system 212, it is preferably generated and supplied automatically in response to the aircraft flight control system 212 determining that one aircraft engine in a twin-engine aircraft is no longer operable.

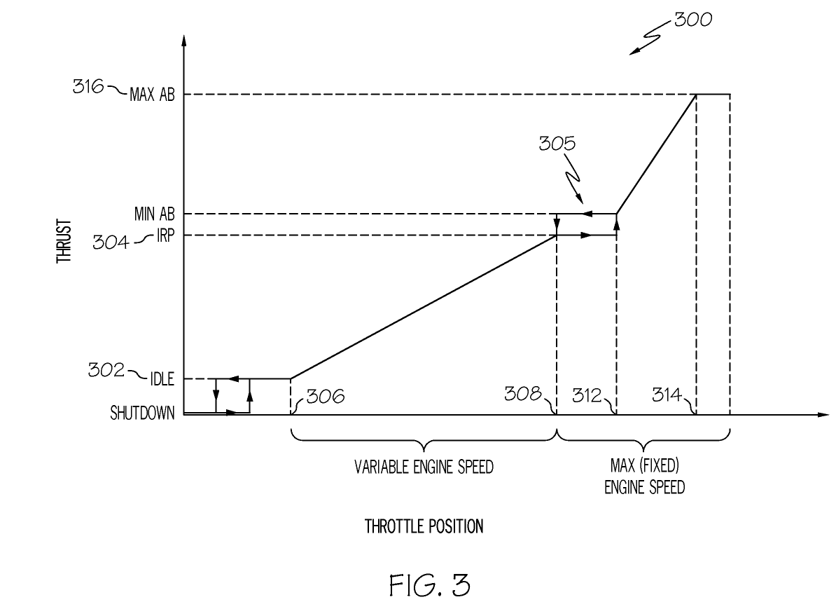

As may be appreciated, when the engine control 150 is controlling the gas turbine engine 110 via the first control logic 202, the gas turbine engine 110 will be operated in the first (“normal”) mode, and when the engine control 150 is controlling the gas turbine engine 110 via the second control logic 204, the gas turbine engine 110 will be operated in the second (“PTR”) mode. Operation and control of the gas turbine engine 110 in the first operational mode may be readily understood with reference to FIG. 3, which graphically depicts the steady state thrust-versus-throttle position response 300 of the gas turbine engine 110 in the first operational mode. As FIG. 3 depicts, when the gas turbine engine 110 is being operated in the first operational mode, it generates thrust using the propulsion turbine 108 (and not the afterburner 144) when it is commanded to generate thrust at a magnitude between the idle engine thrust 302 and the thrust magnitude at maximum engine speed 304. However, when it is commanded to generate thrust at a magnitude greater than the thrust at maximum engine speed 304, the gas turbine engine 110 generates thrust using both the propulsion turbine 108 and the afterburner 144. It is noted that the thrust magnitude at maximum engine speed 304 is labeled “IRP” (Intermediate Rated Power) in FIG. 3. The acronym IRP is a generally well-known acronym that is used to represent the maximum non-afterburning thrust of a gas turbine engine 110.

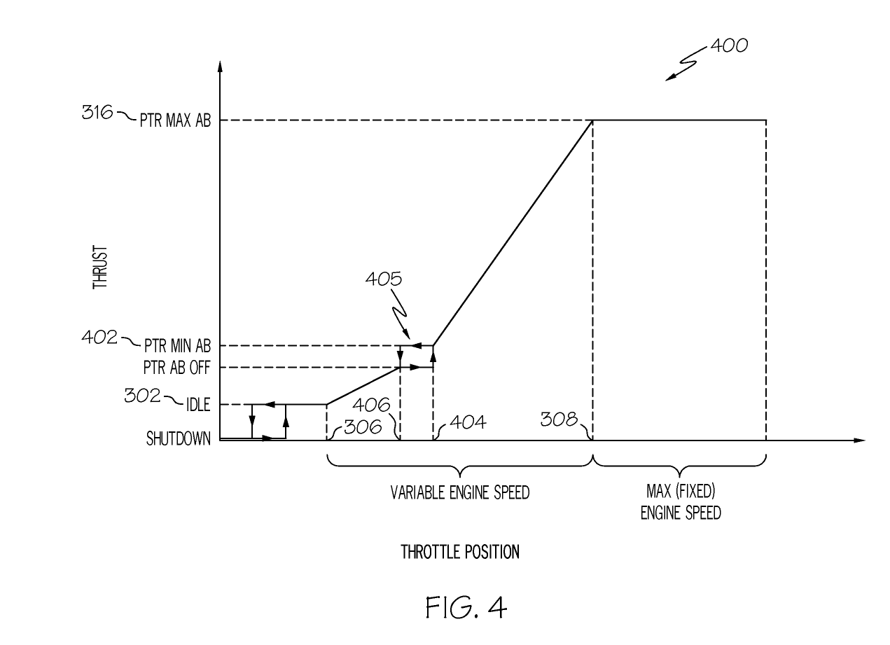

Referring now to FIG. 4, the steady state thrust-versus-throttle position response 400 of the gas turbine engine 110 when it is being operated in the second operational mode is graphically depicted. When the gas turbine engine 110 is being operated in the second operational mode, it generates thrust using the propulsion turbine 108 (and not the afterburner 144) when it is commanded to generate thrust at a magnitude between the idle engine thrust 302 and a first thrust magnitude 402 that is less than the IRP 304. However, when the gas turbine engine 110 is commanded to generate thrust at a magnitude greater than the first thrust magnitude 402, it generates thrust using both the propulsion turbine 108 and the afterburner 144. It will be appreciated that the specific throttle position 404 at which the afterburner 144 is activated, when operating in the second operational mode, may vary. The depicted throttle position 404 (and corresponding generated thrust magnitude 402) is merely provided as an example of one part-throttle position.

Before proceeding further, it is noted that FIGS. 3 and 4 are both depicted to include hysteresis 305 and 405, respectively, associated with activation and deactivation of the afterburner 144. The hysteresis range, in both the first operational mode and the second operational mode, may vary, but is provided to ensure the afterburner 144 is not repeatedly activated and deactivated near the particular activation/deactivation set point.

Returning once again to the description, the first control logic 202 and the second control logic 204 are both configured to control the gas turbine engine 110 to exhibit the steady state thrust-versus-throttle position responses 300 and 400 that are depicted in FIGS. 3 and 4, respectively. As depicted, each of these responses is piecewise linear, with two portions of each response having a non-zero, positive slope. In the first operational mode, the response 300 has a first substantially constant linear slope between a first throttle position 306 and the maximum engine speed throttle position 308, and a second substantially constant linear slope between the throttle position at which the afterburner activates 312 and the throttle position 314 that corresponds to the maximum combined thrust 316 of the propulsion engine 108 and afterburner 144. In the second operational mode, the response 400 has a first substantially constant linear slope between the first throttle position 306 and the throttle position at which the afterburner 144 deactivates 406, and a second substantially constant linear slope between the throttle position at which the afterburner activates 404 and the maximum engine speed throttle position 308.

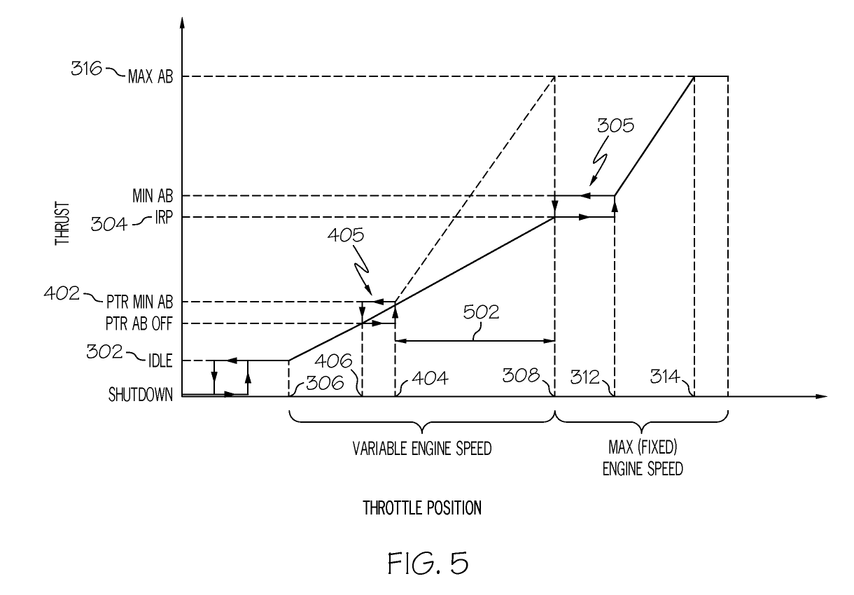

With reference now to FIG. 5, which depicts the two responses 300, 400 overlying each other (response 400 depicted using dashed lines), it is seen that when the PTR mode control logic 204 controls the gas turbine engine 110 to operate in the second operational mode, the slope of the steady state thrust-versus-throttle position response, after the afterburner 144 is activated (e.g., throttle positions≧404), is greater than the slope of the steady state thrust-versus-throttle position response when the normal mode control logic 202 controls the gas turbine engine 110 to operate in the first operational mode, for the same range of throttle positions 502. In a particular preferred embodiment, the slope in the second operational mode, over this range of throttle positions 502, is generally about two times the slope in the first operational mode. As a result, when the gas turbine engine 110 is being operated in the second operational mode, the thrust change it generates over this range of throttle positions 502 is substantially equivalent to the thrust change that two gas turbine engines would generate when operating in the first operational mode. It will be appreciated that the specific value of the slope in the second operational mode over the range of throttle positions 502 may vary over sub-ranges of throttle positions within this range 502. For example, some experimental results indicate slope variations, for some engines, from around 1.68 to 2.13 times the slope in the first operational mode, with the average slope for at least a significant portion of the range 502 being around 1.98 times the slope in the first operational mode.

The ability to selectively implement the PTR control logic 204, and thus operate the gas turbine engine 110 in the second operational mode, provides several advantages. For example, the gas turbine engine 110, for a given amount of throttle device 152 movement, will provide the same amount of thrust change as two gas turbine engines 110 operating in the first operational mode. This will provide a relatively consistent throttle feel to the pilot in the event one gas turbine engine 110 were to become inoperable. This in turn will allow a pilot to implement throttle device movements, during a landing maneuver with one engine, that are generally similar to those used when both engines are running normally.

Selectively operating the gas turbine engine 110 in the second operational mode activates the afterburner 144 at lower engine speeds, and extends the lower end of the thrust range for afterburner 144 operation. This provides the added advantage of eliminating frequent transitions into and out of afterburner 114 operation that can occur when executing a landing maneuver with a single engine. As a result, the thrust response is relatively smooth, without the discontinuity or delay associated with afterburner activation and deactivation. Moreover, the throttle device 152 does not have to be moved to a throttle position beyond the maximum engine speed throttle position 308 and the hysteresis range 305 in order to activate the afterburner 144 and to generate maximum engine thrust.

When the PTR mode control logic 204 controls the gas turbine engine 110 to operate in the second operational mode, if the propulsion turbine 108 and the afterburner 144 are not controlled in a coordinated manner during a commanded thrust transient, the afterburner thrust transient will not synchronize with the propulsion turbine thrust transient. As a result, the overall transient thrust response of the gas turbine engine 110 will likely not be equivalent to that of two gas turbine engines 110. In addition, other deleterious consequences, such as engine surge, afterburner light-off failure, or flameout, could occur. To alleviate these concerns, the PTR mode control logic 204 is additionally configured to synchronize, or at least substantially synchronize, the thrust transients of the propulsion turbine 108 and the afterburner 144 during a commanded thrust transient of the gas turbine engine 110.

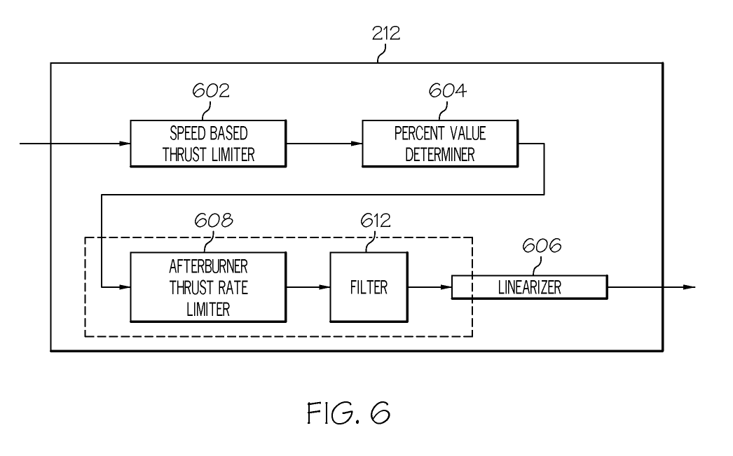

In order to synchronize, or at least substantially synchronize, the propulsion turbine 108 and afterburner 144 thrust transients, the PTR mode control logic 204, as depicted in FIG. 2, implements an afterburner rate limiter 212. The afterburner rate limiter 212 is coupled to receive at least a rotational speed signal from a rotational speed sensor 148 (one of the sensors depicted in FIG. 1) that is configured to sense the rotational speed of the gas turbine engine 110. The afterburner rate limiter 212 is configured, in response to the rotational speed signal, to limit the rate of change of the thrust generated by the afterburner 144 during an afterburner thrust transient. And specifically, to at least substantially match the rate of change of the thrust generated by the afterburner 144 to the rate of change of thrust generated by the propulsion turbine 108. A functional block diagram of one embodiment the afterburner rate limiter 212 is depicted in FIG. 6 and with reference thereto will now be described.

The afterburner rate limiter 212, at least in the depicted embodiment, includes a speed based thrust limiter 602, a percent value determiner 604, and a linearizer 606. The speed based thrust limiter 602 receives the rotational speed signal and is configured, upon receipt thereof, to determine an equivalent steady state throttle position of the throttle device 152. In other words, the speed based thrust limiter 602 calculates the position of the throttle device would be if the sensed engine rotational speed were the steady state rotational speed of the gas turbine engine 110. The percent value determiner 604 receives the equivalent steady state throttle position, and is configured to convert the equivalent steady state throttle position to an equivalent percent value representative of a percentage of the range of throttle positions between positions 404 and 308 (see FIG. 4). The linearizer 606 receives, and is configured to linearize, the equivalent percent value. The output from the linearizer 606 represents the throttle commands for the afterburner 144.

In some embodiments, the output from the percent value determiner 604 is not supplied directly to the linearizer 606. In these embodiments, such as the one depicted in FIG. 6, the afterburner rate limiter 212 may additionally include a percent value rate limiter 608 and a filter 612. The percent value rate limiter 608 receives, and is configured to limit the rate of change of, the equivalent percent value, and the filter 612 receives and filters the rate limited equivalent percent value, and supplies a filtered and rate limited equivalent percent value to the linearizer 608.

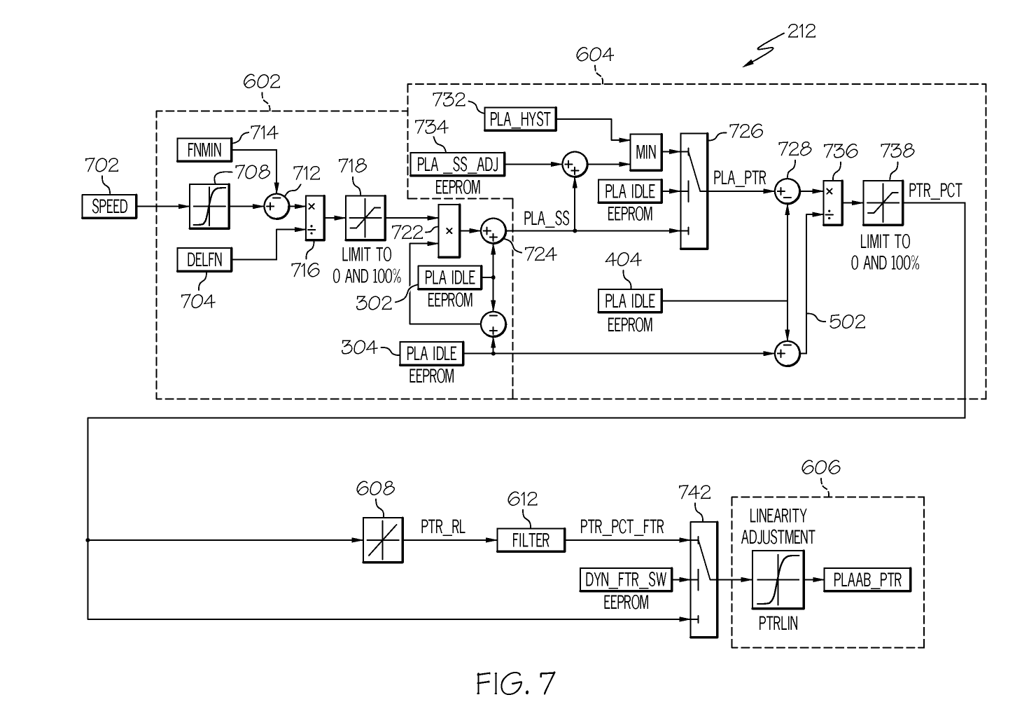

It will be appreciated that the speed based thrust limiter 602, percent value determiner 604, linearizer 606, percent value rate limiter 608, and filter 612 may be variously implemented to carry out the above-described functions. One particular implementation, which may be used with one particular model of gas turbine engine 110, is depicted in FIG. 7, and with reference thereto will, for completeness, now be described.

In the depicted embodiment, the speed signal 702 that is supplied to the speed based thrust limiter 602 is a temperature corrected speed signal 702. In the speed based thrust limiter 602, the speed signal 702 is an input to a speed-to-thrust schedule 708. The speed-to-thrust schedule 708 is a table, or other similar structure, that relates the sensed engine speed to the corresponding engine thrust. The corresponding thrust is then supplied to a subtraction function 712, which subtracts the value 714 that corresponds to the idle engine thrust 302 (FIG. 3) therefrom. The resulting difference is then supplied to a division function 716. The division function 716 divides this value by a value 704 that corresponds to the thrust range between the idle engine thrust 302 and the thrust at maximum engine speed 304 (again, see FIG. 3), and supplies the resulting quotient (which is a percentage thrust value corresponding to the sensed engine speed) to a limiter 718, which limits the value to between 0% and 100%. The percentage thrust value output from the limiter 718 is then supplied to a multiplier function 722, which multiplies the percentage thrust value by the value that corresponds to the range of throttle positions between those associated with idle engine thrust 302 and maximum engine speed 304 (see FIG. 3). The throttle position that corresponds to idle engine thrust 302 is then supplied to another summing function 724, which adds it back to the resulting product that is output from the multiplier function 722. The resulting sum output by the summing function 724 corresponds to the equivalent steady state throttle position of the throttle device 152 (PLA_SS), and is supplied to the percent value determiner 604.

In the depicted percent value determiner 604, the equivalent steady state throttle position (PLA_SS) is supplied to an optional software switch 726. In some embodiments, the software switch 726 may be positioned such that the equivalent steady state throttle position (PLA_SS) is passed directly to a subtraction function 728. In other embodiments, the software switch 726 may be positioned such that the minimum of two values is supplied to the summing function 728. These two values are the predetermined afterburner 144 hysteresis value 732 that was described above (and depicted in FIG. 4) or the resulting sum of the equivalent steady state position and a predetermined adjustment setpoint 734.

It is noted that if the software switch 726 is positioned such that the equivalent steady state throttle position (PCT_SS) is passed directly to the subtraction summing function 728, then thrust modulation of the afterburner 144 will track engine speed. This has the advantage of providing relatively smooth afterburner thrust modulation because engine speed cannot change very fast due to inertia. However, it also exhibits some disadvantages. First, it could produce relatively sluggish and non-synchronized afterburner thrust response because afterburner thrust generation may be slowed down by various control loop dynamics. Second, if main fuel control is failed fixed and engine speed is stuck, then the pilot cannot modulate the afterburner thrust.

Conversely, if the software switch 726 is alternately positioned, then afterburner thrust modulation is more responsive because it does not have to wait for engine speed to change. Moreover, the risk of not reaching minimum afterburner or maximum afterburner thrust near both ends of the range is lessened. The main advantage, however, is its ability to modulate afterburner thrust even if idle speed and maximum engine speed are nearly the same in certain parts of the engine operating envelope.

No matter the specific position of the software switch 726, its output (PLA_PTR) is supplied to the subtraction function 728. The subtraction function 728 subtracts the throttle position at which the afterburner activates 404 when operating in the second mode, from the output (PLA_PTR) of the software switch 726. The resulting difference is supplied to another division function 736, which divides the difference by a value that corresponds to the throttle position range 502 (see FIG. 5). The resulting quotient from the division function 736 (which is a percentage thrust value) is supplied to a second limiter 738, which limits the value to between 0% and 100%. The output of the second limiter 738 (PTR_PCT) is the equivalent percent value representative of a percentage of the throttle position range 502, and is supplied to the linearizer 606 or the percent value rate limiter 608.

The depicted percent value rate limiter 608 and the filter 612 are implemented using fairly standard, conventional techniques. The percent value rate limiter 608 limits the rate of change of the equivalent percent value (PTR_PCT) to specific rates during acceleration and deceleration. The rates are selected to ensure the afterburner 144 is fast enough to synchronize with the propulsion turbine 108, yet slow enough to reduce any disturbances in the rotational speed signal. The filter 612 implements a standard, first-order digital filter and supplies the filtered and rate limited equivalent percent value (PTR_PCT_FTR) to yet another optional software switch 742. In the position depicted in FIG. 7, the filtered and rate limited equivalent percent value (PTR_PCT_FTR) is supplied to the linearizer 606. In the alternative position of the software switch 742, the output of the percent value determiner 604 (PTR_PCT) is supplied directly to the linearizer 606 without being rate limited or filtered. This latter alternative may be used if savings in computational time are needed to achieve the desired afterburner response.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of operating a gas turbine engine that includes a propulsion turbine and an afterburner, the method comprising the steps of:
operating the gas turbine engine in a first operational mode, wherein the gas turbine engine generates thrust using the propulsion turbine and not the afterburner when the gas turbine engine is commanded to generate a thrust between at least a first thrust magnitude and a second thrust magnitude, and the gas turbine engine generates thrust using the propulsion turbine and the afterburner when the gas turbine engine is commanded to generate thrust greater than the second thrust magnitude; and
selectively operating the gas turbine engine in a second operational mode, wherein the gas turbine engine generates thrust using the propulsion turbine and the afterburner when the gas turbine engine is commanded to generate a thrust greater than the first thrust magnitude.

2. The method of claim 1, wherein the thrust generated by the gas turbine engine, when operating in the second operational mode and commanded to generate a thrust greater than the first thrust magnitude, is substantially equivalent to two of the gas turbine engines operating in the first operational mode.

3. The method of claim 1, further comprising:
generating thrust commands based on a position of a throttle device,
wherein, when operating the gas turbine engine in the first operational mode:
the gas turbine engine generates thrust at the first thrust magnitude when the throttle device is in a first position,
the gas turbine engine generates thrust at the second thrust magnitude when the throttle device is in a second position, and
the thrust generated by the gas turbine engine varies substantially linearly with throttle position between at least the first position and the second position,
whereby the gas turbine engine exhibits a first steady state thrust-versus-throttle position response, between at least the first position and the second position, having a first substantially constant linear slope.

4. The method of claim 3, wherein:
the gas turbine exhibits a second steady state thrust-versus-throttle position response between at least the first position and the second position, having a second substantially constant linear slope when operating the gas turbine engine in the second operational mode; and
the second substantially constant linear slope is set to be two times the first substantially constant linear slope, whereby a thrust change of one engine running in the second operational mode is at least substantially equivalent to a combined thrust change of two engines running in the first operational mode when the same amount of throttle position change is applied

5. The method of claim 1, wherein the gas turbine engine is a first gas turbine engine installed on an aircraft having a second gas turbine engine, and wherein the method further comprises:
detecting whether the second gas turbine engine is inoperable; and
upon detecting that the second gas turbine engine is inoperable, automatically operating the first gas turbine engine in the second operational mode.

6. The method of claim 1, further comprising:
detecting a position of a manual switch; and
operating the gas turbine engine in either the first operational mode or the second operational mode based on the detected position of the manual switch.

7. The method of claim 1, further comprising:
substantially synchronizing thrust transients of the propulsion turbine and the afterburner when (i) the gas turbine engine is operating in the second mode and (ii) the gas turbine engine is commanded to undergo a thrust transient between at least the first thrust magnitude and the second thrust magnitude.

8. A method of controlling a gas turbine engine that generates thrust using a propulsion turbine and an afterburner, the method comprising the steps of:
commanding the gas turbine engine to undergo a thrust transient and thereby change the generated thrust from a first thrust magnitude to a second thrust magnitude;
controlling the propulsion turbine to undergo a propulsion turbine thrust transient;
controlling the afterburner to undergo an afterburner thrust transient; and
substantially synchronizing the afterburner thrust transient to the propulsion turbine thrust transient while the generated thrust is changing from the first thrust magnitude to the second thrust magnitude.

9. The method of claim 8, further comprising:
sensing engine rotational speed; and
limiting a rate of change of thrust generated by the afterburner during the afterburner thrust transient based on the sensed engine rotational speed.

10. The method of claim 9, wherein:
the step of commanding the gas turbine engine to undergo a thrust transient comprises changing a position of a throttle device within a range of throttle positions between a minimum position and a maximum position; and
the step of limiting the rate of change of thrust generated by the afterburner comprises:
determining an equivalent steady state position of the throttle device from the sensed engine rotational speed;
converting the equivalent steady state position of the throttle device to an equivalent percent value representative of a percentage of the range of throttle positions between the minimum and maximum positions; and
limiting a rate of change of the equivalent percent value to supply a rate limited equivalent percent value.

11. The method of claim 10, wherein the step of limiting the rate of change of thrust generated by the afterburner further comprises filtering the rate limited equivalent percent value to supply a filtered and rate limited equivalent percent value.

12. The method of claim 11, further comprising linearizing the filtered and rate limited equivalent percent value with a compensation table to provide a linear steady state thrust-versus-throttle position response.

13. A gas turbine engine control system, comprising:
a gas turbine engine including a propulsion turbine and an afterburner; and
an engine control adapted to receive input commands representative of a commanded thrust and configured, in response to the input commands, to:
control the gas turbine engine to generate propulsion thrust using the propulsion turbine and not the afterburner when the commanded thrust is at least between a first thrust magnitude and a second thrust magnitude,
control the gas turbine engine to generate propulsion thrust using both the propulsion turbine and the afterburner when the commanded thrust is greater than the second thrust magnitude, and
selectively control the gas turbine engine to generate propulsion thrust using both the propulsion turbine and the afterburner at least when the commanded thrust is greater than the first thrust magnitude.

14. The system of claim 13, wherein the engine control is further adapted to receive an activation control signal and is further configured, in response to the activation control signal, to control the gas turbine engine to generate propulsion thrust using both the propulsion turbine and the afterburner at least when the commanded thrust is greater than the first thrust magnitude.

15. The system of claim 14, wherein:
the gas turbine engine is a first gas turbine engine installed on an aircraft having a second gas turbine engine, and
the activation control signal is supplied to the engine control in response to the second gas turbine engine becoming inoperable.

16. The system of claim 14, further comprising:
an activation switch in operable communication with the engine control, the activation switch configured to selectively supply the activation control signal to the engine control.

17. The system of claim 14, wherein:
the engine control is operating in a first operational mode when the activation control signal is not received, and in a second operational mode when the activation is received; and
the engine control, when operating in the second operational mode, controls the gas turbine engine to generate propulsion thrust that is substantially equivalent to two gas turbine engines operating in the first operational mode.

18. The system of claim 17, further comprising:
a throttle device movable to a throttle position and configured to supply the input commands based on the throttle position,
wherein, when the engine control is operating in the first operational mode:
the gas turbine engine is controlled to generate propulsion thrust at the first thrust magnitude when the throttle device is in a first throttle position,
the gas turbine engine is controlled to generate propulsion thrust at the second thrust magnitude when the throttle device is in a second throttle position, and
the propulsion thrust generated by the gas turbine engine varies substantially linearly with throttle position between at least the first position and the second position,
whereby the gas turbine engine is controlled to exhibit a steady-state thrust-versus-throttle position response, between at least the first throttle position and the second throttle position, having a first substantially constant linear slope.

19. The system of claim 18, wherein:
the gas turbine engine is controlled to exhibit a steady state thrust-versus-throttle position response, between at least the first throttle position and the second throttle position, having a second substantially constant linear slope when the engine control is operating in the second operational mode; and
the second substantially constant linear slope is approximately two times the first substantially constant linear slope.

20. A gas turbine engine control system, comprising:
a gas turbine engine including a propulsion turbine and an afterburner, the gas turbine engine configured to at least selectively generate thrust using the propulsion turbine and the afterburner; and
an engine control adapted to receive input commands representative of a change in generated thrust from a first thrust magnitude to a second thrust magnitude, the engine control configured, in response to the input commands, to:
control the propulsion turbine to undergo a propulsion turbine thrust transient;
control the afterburner to undergo an afterburner thrust transient; and
substantially synchronize the afterburner thrust transient to the propulsion turbine thrust transient while the generated thrust is changing from the first thrust magnitude to the second thrust magnitude.

21. The system of claim 20, further comprising:
a speed sensor configured to sense a rotational speed of the gas turbine engine and supply a rotational speed signal representative thereof; and
an afterburner rate limiter coupled to receive the rotational speed signal and configured, in response thereto, to limit a rate of change of thrust generated by the afterburner during the afterburner thrust transient.

22. The system of claim 21, further comprising:
a throttle device movable to a throttle position within a range of throttle positions between at least a first position and a second position, the throttle device configured to supply the input commands based on the position thereof; and
wherein the afterburner rate limiter comprises:
a speed-based thrust limiter configured to determine an equivalent steady state position of the throttle device from the sensed engine rotational speed;
a percent value determiner configured to convert the equivalent steady state position of the throttle device to an equivalent percent value representative of a percentage of the range of throttle positions between the first and second positions; and
a percent value rate limiter configured to limit a rate of change of the equivalent percent value and supply a rate limited equivalent percent value.

23. The system of claim 22, wherein the afterburner rate limiter further comprises a filter coupled to receive the rate limited equivalent percent value and configured to filter the rate limited equivalent percent value and supply a filtered and rate limited equivalent percent value.

24. The system of claim 23, further comprising a linearizer coupled to receive the filtered and rate limited equivalent percent value and configured to linearize the filtered and rate limited equivalent percent value with a compensation table to provide a linear steady state thrust-versus-throttle position response.
